(19) United States
(12) Patent Application Publication
(10) Pub. No.: US 2004/0005437 A1
(43) Pub. Date: Jan. 8, 2004

(54) Tile and method for its production

(76) Inventors: Giorgio Mingarelli, Modena (IT); Andrea Mattioli, Sassulo (IT); Cristiana Vandelli, Sassulo Modena (IT)

Correspondence Address: WILLIAM J. SAPONE, COLEMAN SUDOL SAPONE P.C., 714 COLORADO AVENUE, BRIDGE PORT, CT, 06605, US

(21) Appl. No.: 10/332,163

(22) PCT Filed: Jan. 8, 2001
(86) PCT No.: PCT/IB01/00007

(51) Int. Cl. B26D 3/00

(52) U.S. Cl. 428/157; 83/877; 83/49

(57) ABSTRACT

A method for making tiles from plates (1) includes the steps of: making a set of first parallel grooves (2), having a bottom (8) and carried out in the thickness of each plate (1), on the fixing face (3); making at least a set of second parallel grooves (4), having a bottom (5) and carried out in the thickness of each plate (1), on the fixing face (3) and forming an angle (Z) different from zero with the first set of parallel incisions (2); making a set of first through cuts (6) in correspondence of the bottoms (5) of each second groove (4) in order to obtain series of tiles (10) joined only at one side; each first cut (6) having a width smaller than the width of the corresponding groove (4); making a set of second cuts (7) in correspondence of the bottoms (8) of each first groove (2) obtaining separate tiles (10); each second cut (7) having a width smaller than the width of the corresponding groove (2); tumbling the tiles (10).

### TECHNICAL FIELD

The present invention refers to the production of covering materials used in the building trade.

Particularly the invention refers to a method for the production of tiles and the tiles so obtained

for the covering and/or the decoration of floors, building surfaces and architectural elements.

### BACKGROUND ART

There are known methods to carry out tesseras or small tiles by cutting slabs or tiles of bigger dimensions. These known methods provide a cut through all the thickness of the slabs or tiles, starting from the quarry face of these latter.

The main drawback of these known methods is that they allow carrying out tesseras, with absolutely precise and regular edges, which are not suitable for the handicraft coverings and decorations. In fact the regularity of the tesseras carried out using these methods is typical of the industrial products.

Furthermore, there are known methods disclosed, for example, in document EP 0 894 593, providing the obtainment of tesseras or little tiles starting from tiles or slabs in which are made deep grooves starting from the fixing face; the separation of the tiles or slabs in tesseras or little tiles is machine-made or manually made by operators exerting such strengths to fracture the tiles along the incision lines. The resultant fractured edges are irregular and sharp.

A further processing phase allows the chamfering of the fractured edges.

This known method allows to give to tesseras or tiles an irregular aspect but has the main drawback of providing an expensive manual processing phase dangerous for the operators.

A further drawback of this known method is the long processing time that strongly limits the productive capacity.

### DISCLOSURE OF THE INVENTION

The main object of the present invention is to propose a fast, reliable and economic method for the production of tiles with irregular edges having a handcrafted look, starting from plates, consisting of tiles or natural or synthetic slabs.

Another object is to propose a method allowing to produce tiles having at least a rectilinear regular edge fit for the joining with other coverings or for carrying out the end portions of covering and having irregular remaining edges.

The objects above-mentioned are achieved according with the content of the claims.

### BRIEF DESCRIPTION OF THE DRAWINGS

The characteristics of the invention are underlined in the following with particular reference with the attached drawings, in which:

FIG. 1 shows an axonometric view of plates during the processing phase according to the method object of the present invention, in order to carry out tiles using means shown in schematic way;

figures from 2A to 2C show partial section views of progressive phases of grooves realization in the plates;

FIG. 2D shows a side view of separate tiles according to the method in object;

figures from 3A to 3C show views related to those of figures from 2A to 2C regarding progressive separation phases of the tiles;

FIG. 3D shows a side view of two separate tiles according to a variation of the method in object;

FIG. 4 shows an axonometric view of a plate split in tiles according to the method phases shown in the figures from 2A to 2D;

FIG. 5 shows an enlarged and rotated view of one of the tiles of FIG. 4;

FIG. 6 shows an axonometric view of a plate split in tiles according to the phases of the method variation shown in the figures from 3A to 3D;

FIG. 7 shows an enlarged and rotated view of one of the tiles of the right lower side of FIG. 6;

FIG. 8 shows a top view of a tiles plurality of FIG. 5 in an adjacent exemplifying assembly position;

FIG. 9 shows a top view of a plurality of tiles similar to those of FIG. 7 in an adjacent exemplifying assembly position;

FIG. 10 shows a cross section view of a plurality of tiles of FIG. 5 in an assembly condition;

FIG. 11 shows a cross section view of a plurality of tiles of FIG. 7 in an assembly condition.

### BEST MODE OF CARRYING OUT THE INVENTION

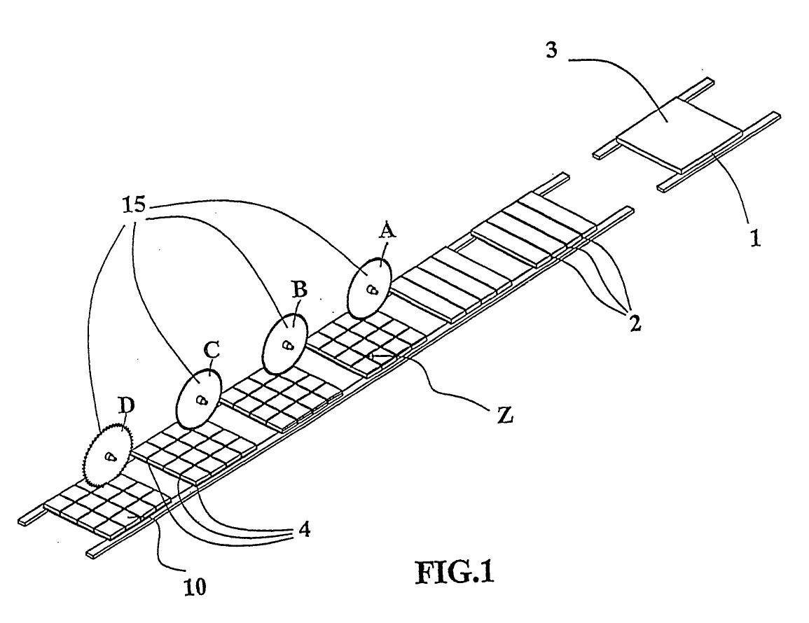

In FIG. 1 the numeral 1 indicates a plate, for instance a covering tile or a slab of natural or synthetic material, for instance porphyry, granite, stone or conglomerate.

The plates 1 are moved with respect to a plurality of disk-type milling cutters 15 rotated by means of known and not illustrated devices. The plates 1 have the face 3, to be fixed to the floor or to the wall, faced to the cutters.

The plates in their relative motion meet the cutters 15 divided in four following groups A, B, C, D; each group is represented in FIG. 1 by a single cutter, for simplicity and clarity. Each cutter 15 of each group is aligned with the corresponding cutters 15 of the other groups and with the direction of the relative motion of the plates 1. The cutters 15 of the groups are equidistant.

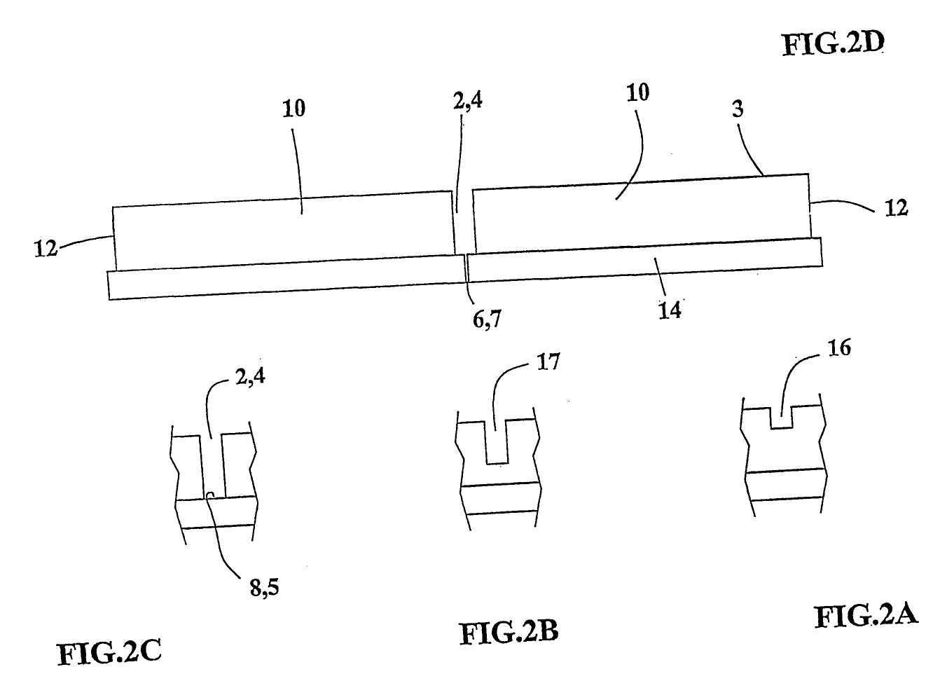

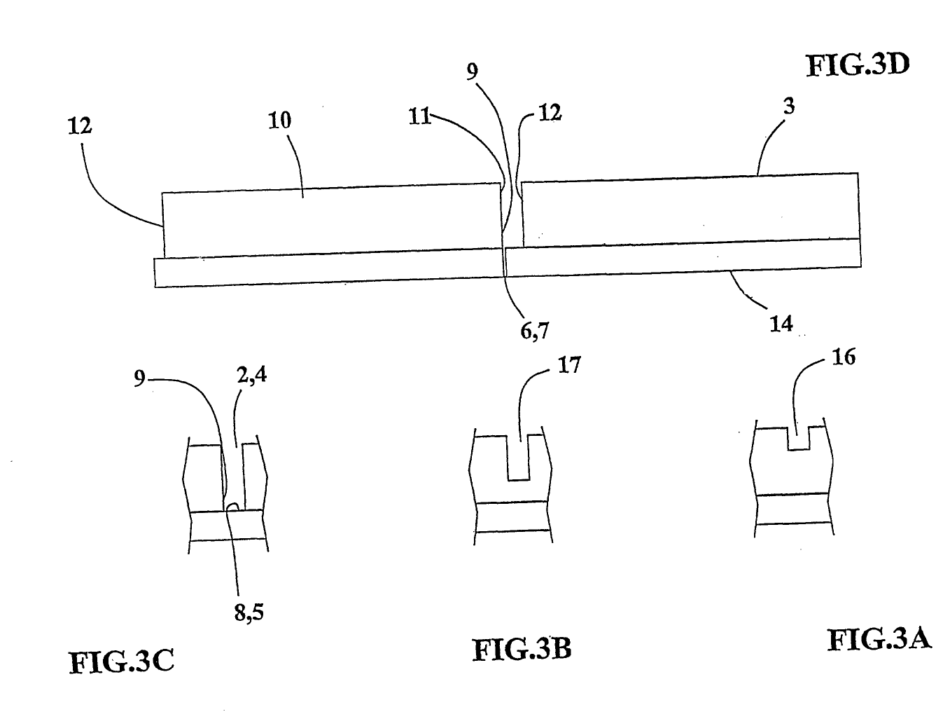

With reference to the figures from 2A to 3D, each of the first three groups A, B, C of cutters 15 met in succession by every plate 1 carry out progressively a set of related second grooves 4: every cutter 15 of the group A carry out a first groove 16 (FIG. 2A); every cutter 15 of the group B deepens the first groove 16 up to the second groove 17 dimensions (FIG. 2B); the group C deepens the groove up to the second grooves 4 defining a bottom 5.

It is important to notice that the realization in successive steps, in three progressive passages of the grooves 1 allows an advantageous increase of speed in the execution of these latter and an advantageous reduction of the risks of breaking the plate 1.

The fourth group D of cutters 15 carry out in the bottom 5 of every second groove 4 a respective first through cut 6 that ends up to the quarry face 14 of the plate 1. The cutters 15 of the group D have smaller thickness in comparison to those of the groups A, B, C so that the thickness of the cuts 6 is smaller than the width of the grooves 4.

Every first cut 6 can be carried out in the bottom 5 in correspondence of the median portion of this latter or, in a variant of the method object of the invention, in correspondence of a side portion 9 of the second groove 4.

In the first case both the correspondent perimetrical sides of the tiles 10 are “L” shaped, while in the second case there are, in correspondence of the side portion 9, a plain perimetrical side 11 and, faced out, a perimetrical side 12 “L” shaped.

The execution of the first cut 6 in correspondence of the portion 9 is carried out translating transversally the position of the corresponding cutters 15 of the fourth group.

As it is evident from the FIG. 1, the plates 1 receive, before the execution of the seconds grooves 4, a similar processing through similar means that produce first grooves 2 completely similar to the second grooves 4.

The preferred embodiment of the method and the tiles so carried out, provides that the first grooves 2 form a 90° angle Z with the second grooves 4.

Downstream of the fourth group A of cutters 15, the plate 1 is cut in strips that is in a series of tiles 10 still partially joined along a perimetrical side which is cut, in correspondence of the first grooves 2, by means of a second through cut 7 having the same execution and the same cutting means of the first cut 6.

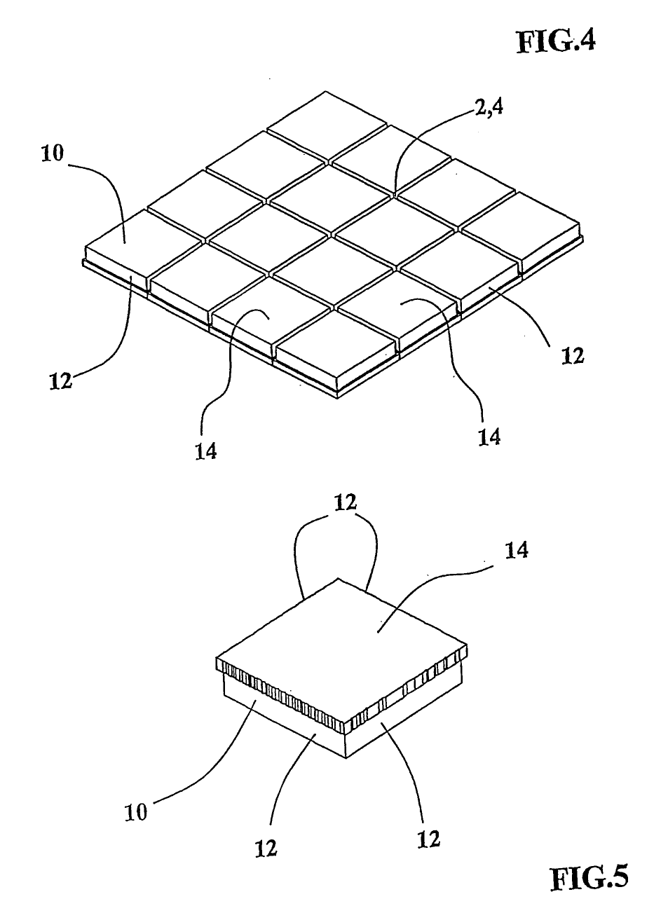

The FIG. 4 shows a portion of plate 1 split in tiles 10 separated by through cuts, first 6 and second 7, carried out in the median portions of the grooves 2, 4.

The FIG. 5 shows one of the tiles 10 of the FIG. 4 where the perimetrical “L” shaped sides 12 are evident.

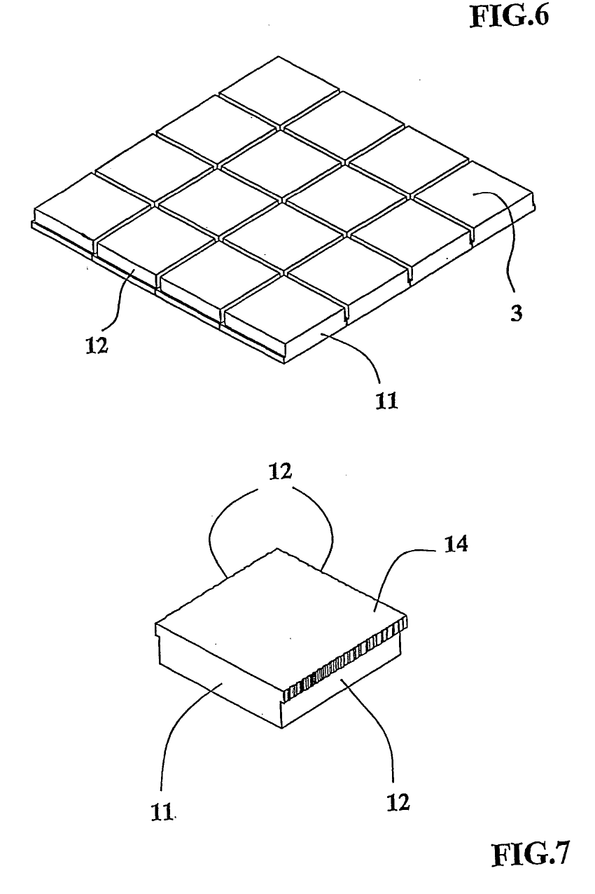

The FIG. 6 shows a plate portion 1 split in tiles 10.separated.by through cuts first 6 and second 7 carried out in the median portions of the grooves 2, 4 excluding the groove cut at right low position which has been carried out in the side portion 9 of the corresponding groove.

The FIG. 7 shows one of the tiles 10 of the FIG. 6 having three perimetrical “L” shaped sides 12 and a flat side 11.

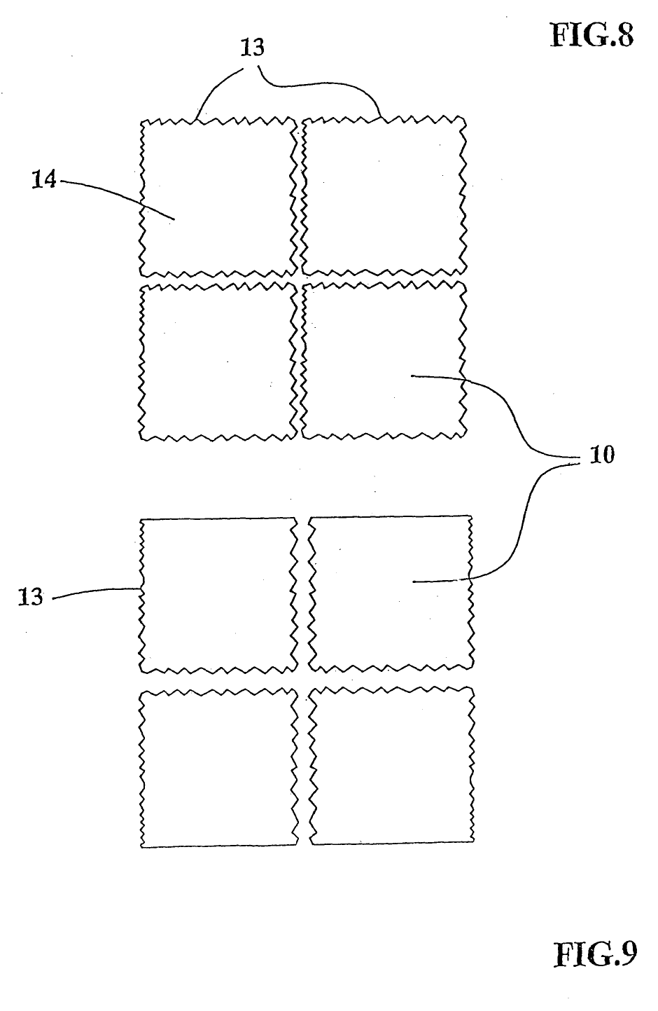

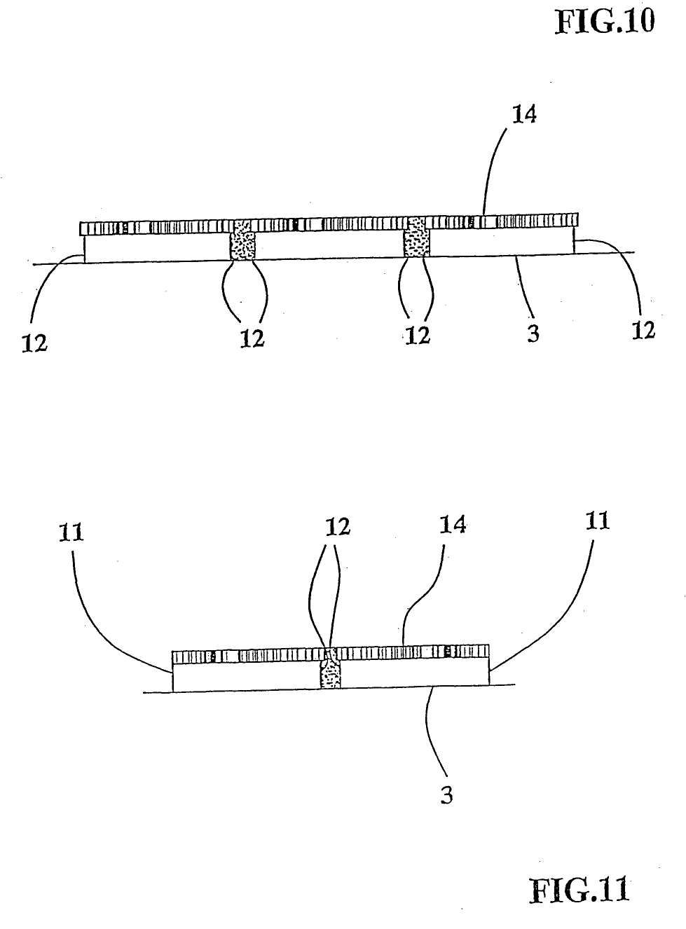

In FIG. 8, numeral 13 indicates irregularities of the edge between the shaped perimetrical sides 12 and the quarry face 14 of the tile 10; said edge corresponds to a small thickness of the tile 10 equal to the depth of the correspondent cut 6,7 and it is subject to splinters and fractures caused by a tumbling phase originating the irregularities 13.

In FIG. 9 there are shown tiles 10 whose upper and lower edges are nearly rectilinear and without irregularity 13 because they correspond to flat perimetrical sides 11 indifferent to the tumbling action.

Then the method for obtaining tiles starting from plate 1 carry out, in sequence, a set of first parallel grooves 2 carried out in the thickness of every plate 1 starting from the fixing face 3; at least a set of second parallel grooves 4 carried out in the thickness of every plate 1 starting from the fixing face 3 and forming an angle Z different from zero with the first set of parallel incisions 2; a set of first through cuts 6 in correspondence of each bottom 5 of each second groove 4 in order to obtain series of tiles 10 joined at a single side; each first cut 6 having a width smaller than the corresponding groove width; a set of second cuts 7 in correspondence of each bottom 8 of each first groove 2 obtaining separated tiles 10; each second cut 7 having a width smaller than the corresponding groove width.

The method provides to submit the tiles 10 to a final tumbling whose stresses cause irregularities 13 along the edges between the quarry face 14 and the shaped perimetrical sides 12 of the tiles 10.

The average dimensions of the irregularities 13 can be varied operating on the width of the grooves, first 2 and second 4, or on the depth of these grooves that cause a different depth of the through cuts, first 6 and second 7, and therefore a different “brittleness degree” of the sharp edges of the quarry face 14 of every tiles during the tumbling phase.

The method further carry out the first parallel grooves 2 crossing the second parallel grooves 4 with an angle Z included between 120° and 60° in order to obtain tiles 10 shaped as skew parallelogram, for instance a rhomb or a stretched lozenge.

The distances between the first grooves 2 are constant, while the distance between the second grooves 4 can be also constant with a value different or equal of the distance between the first grooves. In the first case, according to the angle Z value; the tiles are rectangular or shaped as an irregular parallelogram; in the second case they are square or shaped as a rhombus or a lozenge.

The main advantage of the present invention is to provide a fast, sure and economic method for carrying out tiles with different shapes and with all or some irregular quarry edges.

1) Method for making tiles from plates (1) characterized in that it includes the steps of:
making a set of first parallel grooves (2), having a bottom (8) and carried out in the thickness of each plate (1), on the fixing face (3);
making at least a set of second parallel grooves (4), having a bottom (5) and carried out in the thickness of each plate (1), on the fixing face (3) and forming an angle (Z) different from zero with the first set of parallel incisions (2);
making a set of first through cuts (6) in correspondence of the bottoms (5) of each second groove (4) in order to obtain series of tiles (10) joined only at one side; each first cut (6) having a width smaller than the width of the corresponding groove (4);
making a set of second cuts (7) in correspondence of the bottoms (8) of each first groove (2) obtaining separate tiles (10); each second cut (7) having a width smaller than the width of the corresponding groove (2);
tumbling the tiles (10).

2) Method according to claim 1 characterized in that carries out the first grooves (2) crossing the second grooves (4) with a 90° angle (Z) so obtaining right parallelogram tiles (10)

3) Method according to claim 1 characterized in that carries out the first grooves (2) crossing the second grooves (4) with an angle (Z) ranging from 60° to 120° so obtaining tiles (10) rhomb or lozenge shaped.

4) Method according to claim 1 characterized in that carries out the cuts, first (6) and second (7), in correspondence of the median portion of each bottom (8, 5) of each groove, first (2) and second (4).

5) Method according to the claim 1 characterized in that includes the steps of:
making a subset of the cuts, first (6) and second (7), in correspondence of the median portion of each bottom (8, 5) of each groove, first (2) and second (4);
making the subset complementary to the precedent set of cuts first (6) and second (7) on each bottom (8, 5) of each groove first (2) and second (4) in correspondence of a side portion (9) of these latter.

6) Method according to any of the preceding claims characterized in that carries out each groove first (2) and second (4) by means of a sequence of three millings progressively deeper.

7) Method according to any of the preceding claims characterized in that carries out the first grooves (2) equidistant.

8) Method according to any of the preceding claims characterized in that carries out the second grooves (4) equidistant.

9) Method according to any of the preceding claims characterized in that it carries out equidistant the grooves first (2) and seconds (4).

10) Method according to any of the preceding claims characterized in that includes the average seize setting of-the irregularities (13) of the tile quarry face (14) operating on the width of the grooves, first (2) and seconds (4).

11) Method according to any of the preceding claims characterized in that includes the average seize setting of the irregularities (13) of the tile quarry face (14) operating on the depth of the grooves, first (2) and seconds (4), causing a different depth of the through cuts, first (6) and second (7).

12) Method according to any of the preceding claims characterized in that includes the average seize setting of the irregularities (13) of the tile quarry face (14) operating on the intensity and the duration of the tumbling phase.

13) Tile characterized in that includes:
a first subset of flat perimetrical sides (11) having an almost regular and rectilinear edge with the quarry face (14);
a second subset, complementary to the first one (11), of perimetrical side (12) “L” shaped having irregularities (13) on the common edge with the quarry face (14).

14) Tile characterized in that the edges of the quarry face (14) are chamfered.
